(19) United States
(12) Patent Application Publication
(10) Pub. No.: US 2011/0048203 A1
(43) Pub. Date: Mar. 3, 2011

(54) Workpiece Supporting Device Of A Circular Sawing Machine

(75) Inventors: Chia-Hsin Cheng, Taichung (TW); Mei-Lan Kao, Taichung (TW)

(73) Assignee: P & F Brother Industrial Corporation, Taichung (TW)

(21) Appl. No.: 12/547,019

(22) Filed: Aug. 25, 2009

(51) Int. Cl. B23D 47/02; B23D 47/04

(52) U.S. Cl. 83/471.3; 83/473

(57) ABSTRACT

A workpiece supporting device of a circular sawing machine includes a base frame for rotatably supporting a worktable and having an arcuate surface region which defines an angularly extending guiding route. A platform is disposed on and is movable along the guiding route, and has an upper mounting surface that cooperates with the worktable to support a workpiece. A tightening mechanism is displaceable between unmovable and movable positions, where the platform is brought into tight and loose engagements with the arcuate surface region. An actuator is coupled with the tightening mechanism is operable to displace the tightening mechanism. The platform is movable along the guiding route when the tightening mechanism is in the movable position such that the worktable is turnable within a relatively large angular range.

### BACKGROUND OF THE INVENTION

1. Field of the Invention

This invention relates to a circular sawing machine, more particularly to a workpiece supporting device of a circular sawing machine having a worktable that is turnable relative to a base frame within a relatively large angular range.

2. Description of the Related Art

Referring to FIG. 1, a conventional circular sawing machine 10 generally includes abase frame 11, a turntable 12 rotatably mounted on the base frame 11, and a circular saw unit 13 cantileveredly mounted over the turntable 12 and pivotably movable toward and away from the turntable 12. The base frame 11 is provided with left and right platforms 111 for supporting a workpiece. Left and right fences 112 are supported respectively on the left and right platforms 111 for positioning the workpiece. The circular saw unit 13 has a circular saw blade 131 and a handle 132. The turntable 12 includes a neck table portion 121 extending forwardly, and a locking member 122 disposed on a front end of the neck table portion 121. In use, a user can grip the handle 132 to move the circular saw unit 13 downward to perform a cutting operation.

The user can turn the turntable 12 to a desired angular position, tighten the locking member 122 to lock the turntable 12 at the desired angular position, and move the circular saw unit 13 toward the turntable 12 for cutting the workpiece. Thus, the turntable 12 is operable to cut the workpiece at different angular positions. However, since a left or right side of the neck table portion 121 will abut against the left or right platform 111 during a cutting operation so as to limit the angular adjustment of the turntable 12 to be within a range defined by the platform 111 and the neck table portion 121, the angular cutting angles of the circular saw blade 131 relative to the workpiece are limited.

### SUMMARY OF THE INVENTION

The object of the present invention is to provide a workpiece supporting device of a circular sawing machine in which a turntable for supporting a workpiece is rotatable relative to a base frame within a relatively large angular range.

According to this invention, the workpiece supporting device of a circular sawing machine includes a base frame having a major wall to which a central axis is normal. An upper major wall surface of the major wall has a central area which supports a worktable, a frontward surface region which extends radially and outwardly from the central area, and an arcuate surface region which extends rearwardly from the frontward surface region. The arcuate surface region defines a guiding route extending angularly about the central axis. A platform is disposed to be movable along the guiding route so as to turn about the central axis, and has an upper mounting surface that cooperates with an upper table surface of the worktable to support a workpiece. A tightening mechanism is disposed to be displaceable between an unmovable position, where the platform is brought into tight engagement with the arcuate surface region, and a movable position, where the platform is brought into loose engagement with the arcuate surface region. An actuator includes a shank rotatable relative to the base frame, an actuated end coupled with the tightening mechanism to displace the tightening mechanism from the unmovable position to the movable position to thereby permit the platform to be movable along the guiding route, and an operated end disposed to facilitate manual turning of the shank about the rotating axis. Preferably, the actuated end has a cam which is rotatably engaged with a cam follower of the tightening mechanism such that turning of the cam results in movement of the tightening mechanism relative to the platform so as to bring the platform into tight or loose engagement with said arcuate surface region.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a conventional circular sawing machine;

FIG. 2 is an exploded perspective of the first preferred embodiment of a workpiece supporting device of a circular sawing machine according to this invention;

FIG. 3 is a fragmentary exploded perspective view of a portion of the first preferred embodiment;

FIG. 4 is a top view of the first preferred embodiment;

FIG. 5 is a front view of the first preferred embodiment;

FIG. 6 is a bottom view of the first preferred embodiment;

FIG. 7 is a sectional view taken along lines VII-VII of FIG. 6, illustrating a tightening mechanism in an unmovable position;

FIG. 8 is a sectional view taken along lines VIII-VIII of FIG. 6;

FIG. 9 is a sectional view taken along lines IX-IX of FIG. 6;

FIG. 10 is a top view illustrating a state in which a worktable is permitted to be turnable within a relatively large angular range;

FIG. 11 is a sectional view similar to FIG. 8, illustrating the tightening mechanism in a movable position;

FIG. 12 is a sectional view similar to FIG. 9, illustrating the tightening mechanism in the movable position;

FIG. 13 is a sectional view of a portion of the second preferred embodiment according to this invention; and

FIG. 14 is a sectional view taken along lines XIV-XIV of FIG. 13.

### DETAILED DESCRIPTION OF THE PREFERRED EMBODIMENTS

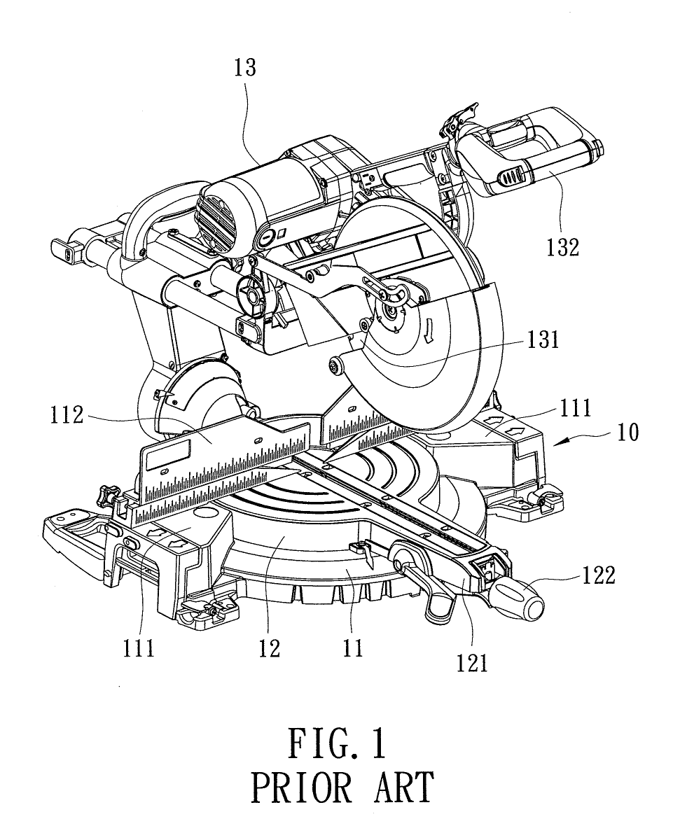

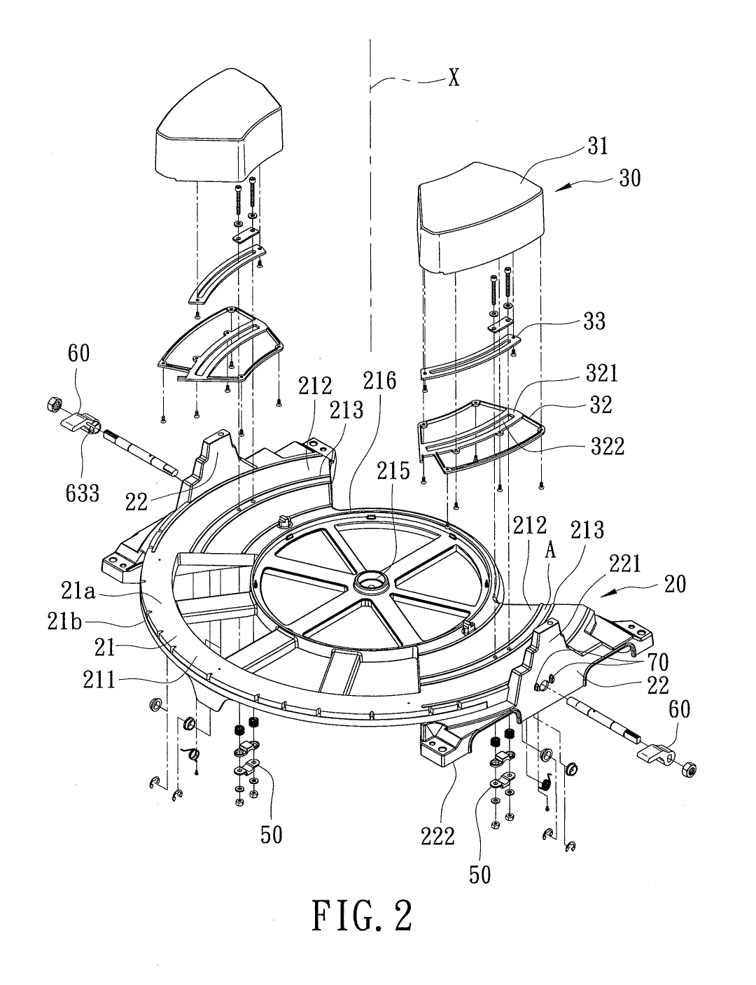

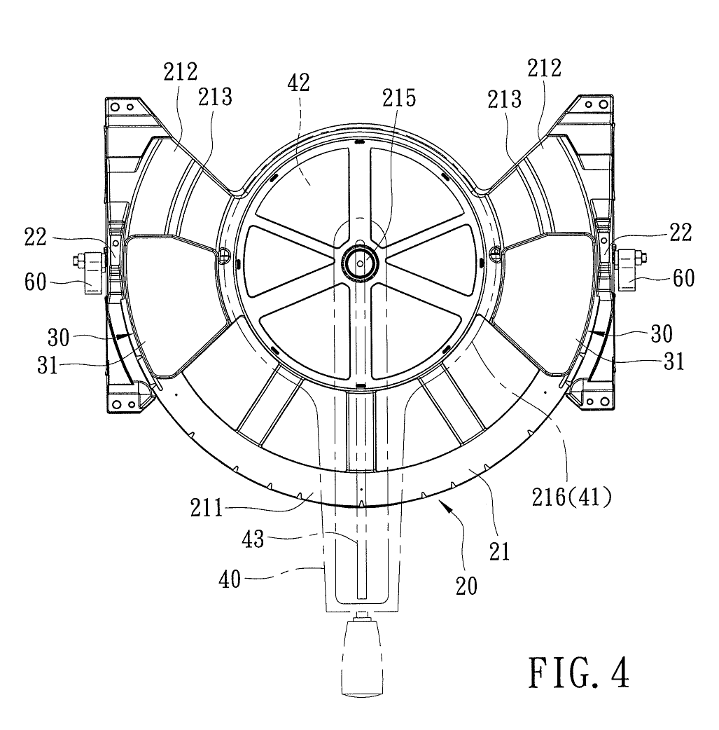

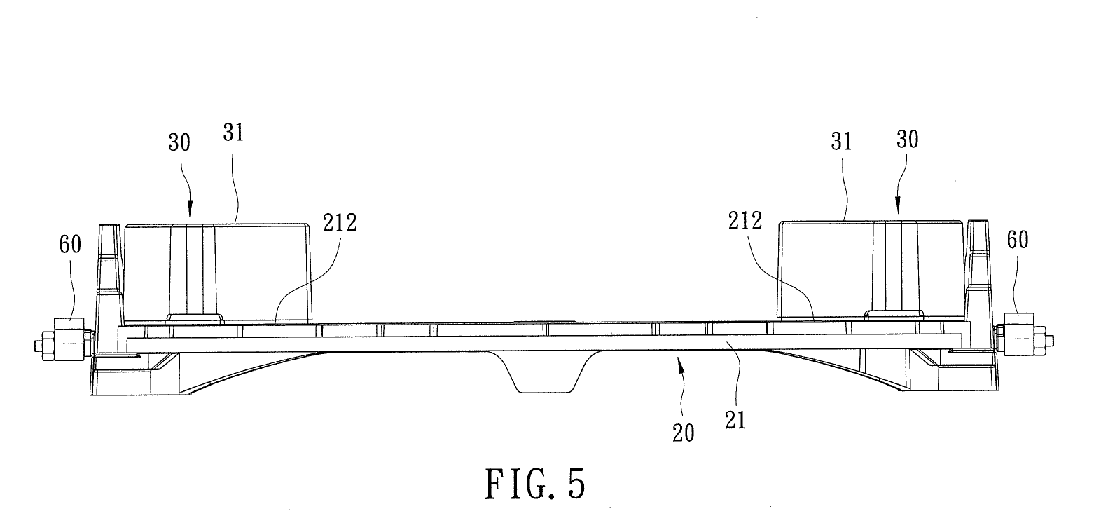

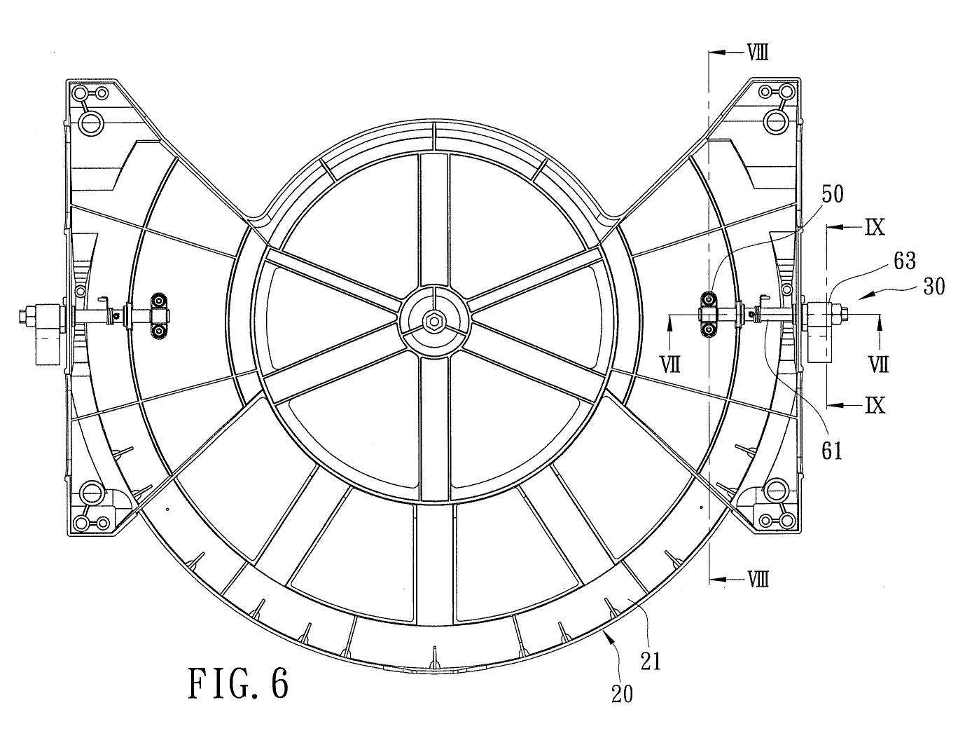

Referring to FIGS. 2 to 6, the first preferred embodiment of a workpiece supporting device of a circular sawing machine according to the present invention is shown to comprise a base 20, a worktable 40, left and right platforms 30, left and right tightening mechanisms 50, left and right actuators 60, and left and right stopping units 70. The circular sawing machine includes a circular saw unit (see FIG. 1) that is cantileveredly mounted over the workpiece supporting device to be pivotably movable toward and away from the workpiece supporting device.

The base 20 includes a base frame 21 and left and right mounts 22. The base frame 21 has a major wall to which a central axis (X) is normal, and which has upper and lower major wall surfaces (21a, 21b) opposite to each other in an upright direction. The upper major wall surface (21a) has a central area 215 which has a circumferential borderline 216 surrounding the central axis (X), a frontward surface region 211 which extends radially and forwardly of the circumferential borderline 216 and which angularly extends about the central axis (X), and left and right arcuate surface regions 212 which extend rearwardly from the frontward surface region 211. Each of the arcuate surface regions 212 has an arcuate rail unit 213 including inner and outer arcuate rails that extend angularly about the central axis (X) and that are spaced apart from each other by an arcuate zone (A) and that serve as a guiding route 213.

The left and right mounts 22 respectively flank the left and right arcuate surface regions 212. Each of the mounts 22 extends uprightly to form a sidewall segment 221 and a base segment 222 that rests on a flat surface, such as the surface of a workbench, a floor surface, etc., to suspend the respective arcuate surface region 212 from the flat surface such that the base segment 222 is disposed below the lower major wall surface (21b).

The worktable 40 has an outer periphery 41 aligned with the circumferential borderline 216 and is superimposed on the central area 215. The worktable 40 has an upper table surface 42 which defines a cutting line 43 that extends from the central axis (X) towards a foremost point of the frontward surface region 211, and that serves as a reference for guiding movement of the circular saw unit toward the workpiece supporting device for cutting a workpiece.

The left and right platforms 30 are movable along the arcuate rail units 213, respectively, so as to turn about the central axis (X). Each of the platforms 30 has an upper mounting surface 31 that cooperates with the upper table surface 42 of the worktable 40 to support the workpiece, and a bottom frame 32 which is spaced apart from the upper mounting surface 31 and which includes a slidable arcuate web 321 that extends angularly about the central axis (X), that is made from a wear-resistant material, and that is guided to slide on the respective arcuate rail unit 213. The slidable arcuate web 321 has an arcuate slot 322 which extends therethrough and which is aligned with the arcuate zone (A) in the upright direction. Each of the platforms 30 further has a force-focusing member 33 which is configured to resemble the slidable arcuate web 321 and has an arcuate slot 331 and which is superimposed upon the slidable arcuate web 321.

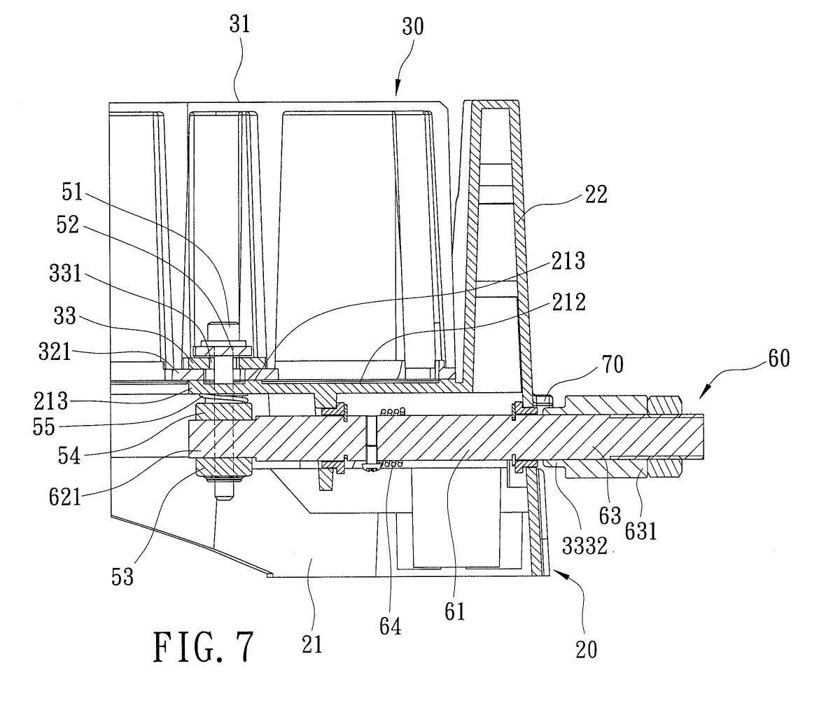

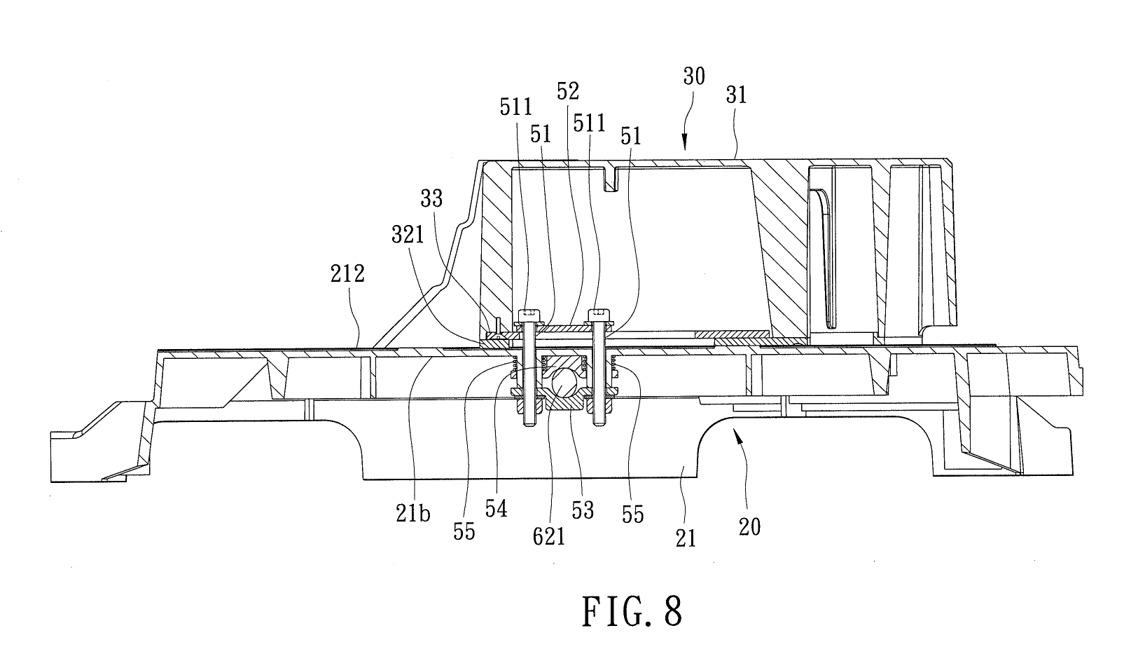

Each of the left and right tightening mechanisms 50 includes a bolt unit having two bolts 51, an elongated washer body 52, a cam follower 53, a bearing member 54, and two coil springs 55. With reference to FIGS. 7 and 8, the bolts 51 are angularly spaced apart from each other, are engaged with the respective arcuate zone (A), and respectively extend in the upright direction through the arcuate slots 322, 331 to terminate at enlarged heads 511, respectively. The bolts 51 are movable relative to the respective arcuate zone (A) and the respective slidable arcuate web 321 in the upright direction. The elongated washer body 52 has two through bores for extension of the bolts 51 therethrough, respectively, and are configured to force the respective force-focusing member 33 to abut against the respective slidable arcuate web 321. The enlarged heads 511 of the bolts 51 are movable in the upright direction between a movable position, where the respective slidable arcuate web 321 is in loose engagement with the respective arcuate rail unit 213 so as to permit the respective platform 30 to slide along the respective guiding route, and an unmovable position, where a pressing force emanating from the enlarged heads 511 is focused by the elongated washer body 52 onto the respective slidable arcuate web 321 so as to bring the respective slidable arcuate web 321 into tight engagement with the respective arcuate rail unit 213, thereby tightening the respective platform 30 on the respective arcuate surface region 212. Furthermore, the bolts 51 extend downwardly to terminate at lower ends that are disposed below the lower major wall surface (21b) of the base frame 21. The cam follower 53 interconnects the lower ends of the bolts 51 and has a follower surface 531 confronting the lower major wall surface (21b). The bearing member 54 interconnects and is movable relative to the lower ends of the bolts 51 in the upright direction, and has a bearing surface 541 confronting the follower surface 531. The coil springs 55 are respectively sleeved on the lower ends of the bolts 51, and are disposed between the lower major wall surface (21b) and the bearing member 54 so as to bias the bearing member 54 downwardly and away from the lower major wall surface (21b).

Each of the left and right actuators 60 includes a shank 61, an actuated end 62, an operated end 63, and a torsion spring 64. The shank 61 is rotatably mounted in the base segment 222 of the respective mount 22 about a rotating axis (R), and extends along the rotating axis (R). The actuated end 62 is disposed inwardly of the shank 61, and has a cam 621 which is frictionally engaged with and which is rotatably interposed between the follower and bearing surfaces 531, 541 to be turned with the shank 61 about the rotating axis (R). The operated end 63 extends from the shank 61 and outwardly of the base segment 222 of the respective mount 22, and has a handle 631 to facilitate manual turning of the cam 621 about the rotating axis (R). The torsion spring 64 has two ends respectively engaging the shank 61 and the lower major wall surface (21b). The handle 631 has a bent portion 632 for manual operation by the user, and a protrusion 633 facing the base segment 222 of the respective mount 22.

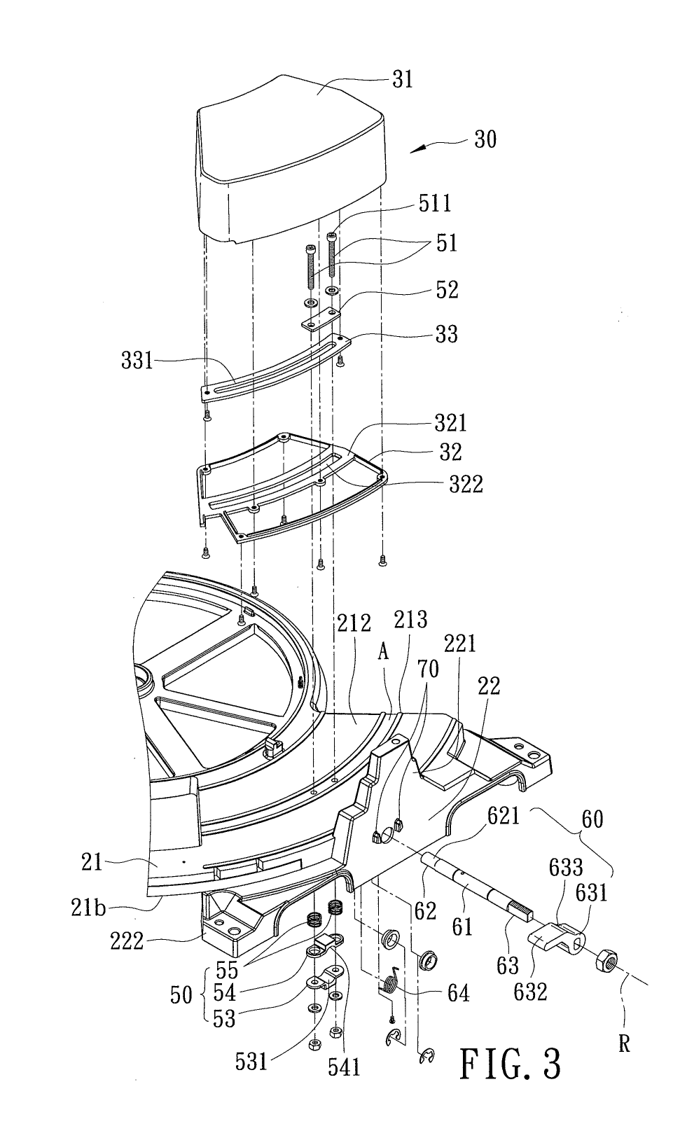

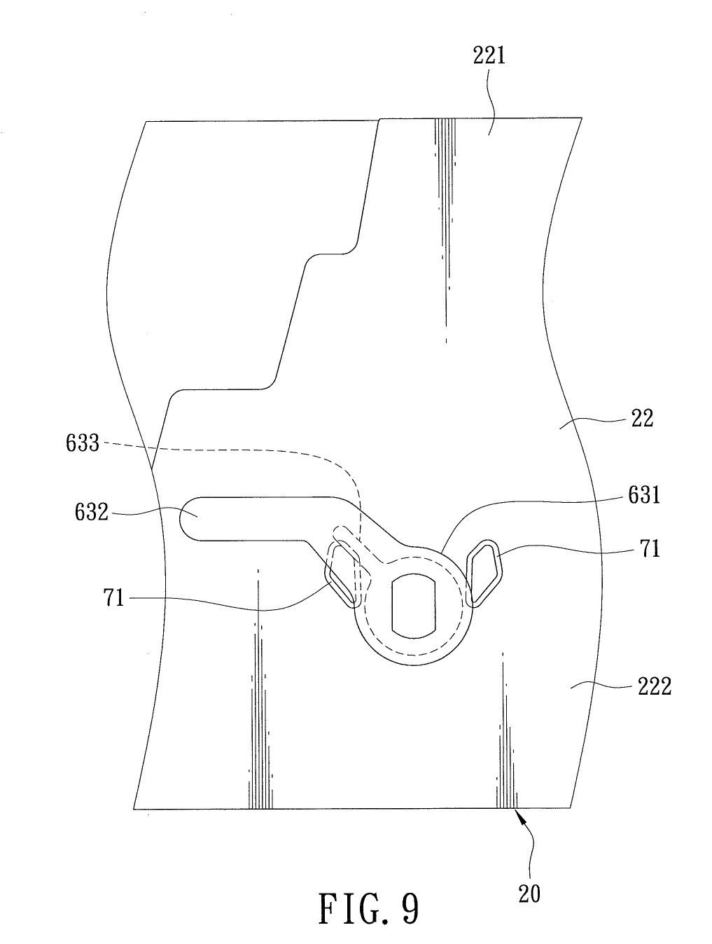

With reference to FIGS. 3 and 9, each of the left and right stopping units 70 includes front and rear stoppers 71 which are disposed on the base segment 222 of the respective mount 22 such that the protrusion 633 is stopped by the stoppers 71 during operation of the handle 631 so as to limit the extent of turning of the operated end 63 about the rotating axis (R).

Referring to FIGS. 7, 8 and 9, when one of the left and right tightening mechanisms 50 is in the unmovable position, the respective handle 631 is operable to cause the protrusion 633 to abut against the front stopper 71. At this stage, the cam follower 53 and the bearing member 54 are moved away from each other in the upright direction by the cam 621 such that the bolts 51 are moved downwardly to bring the slidable arcuate web 321 into tight engagement with the arcuate rail unit 213, and the bearing member 54 is in tight engagement with the lower major wall surface (21b) so as to secure the respective platform 30 on the respective arcuate surface region 212.

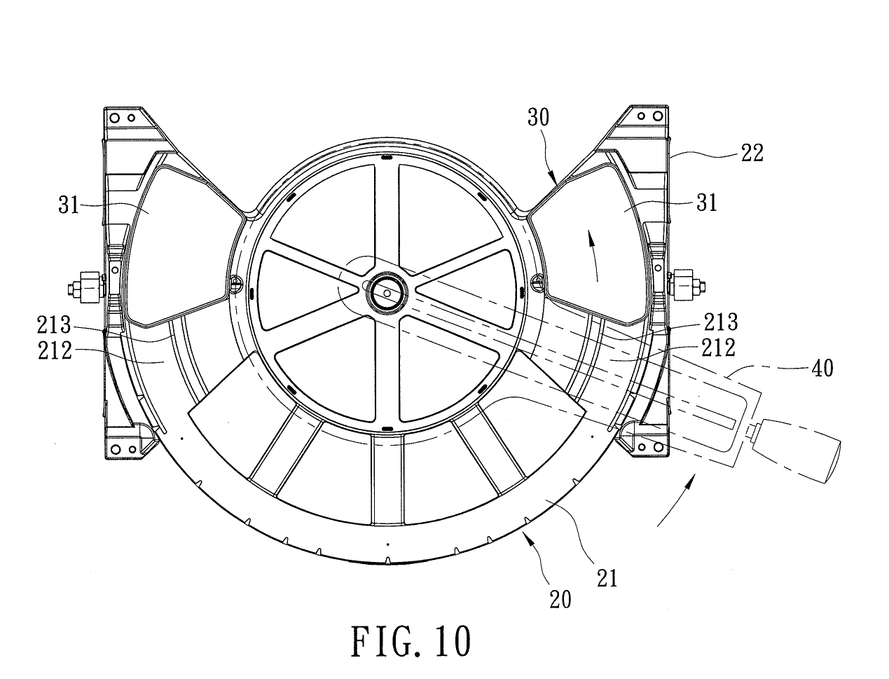

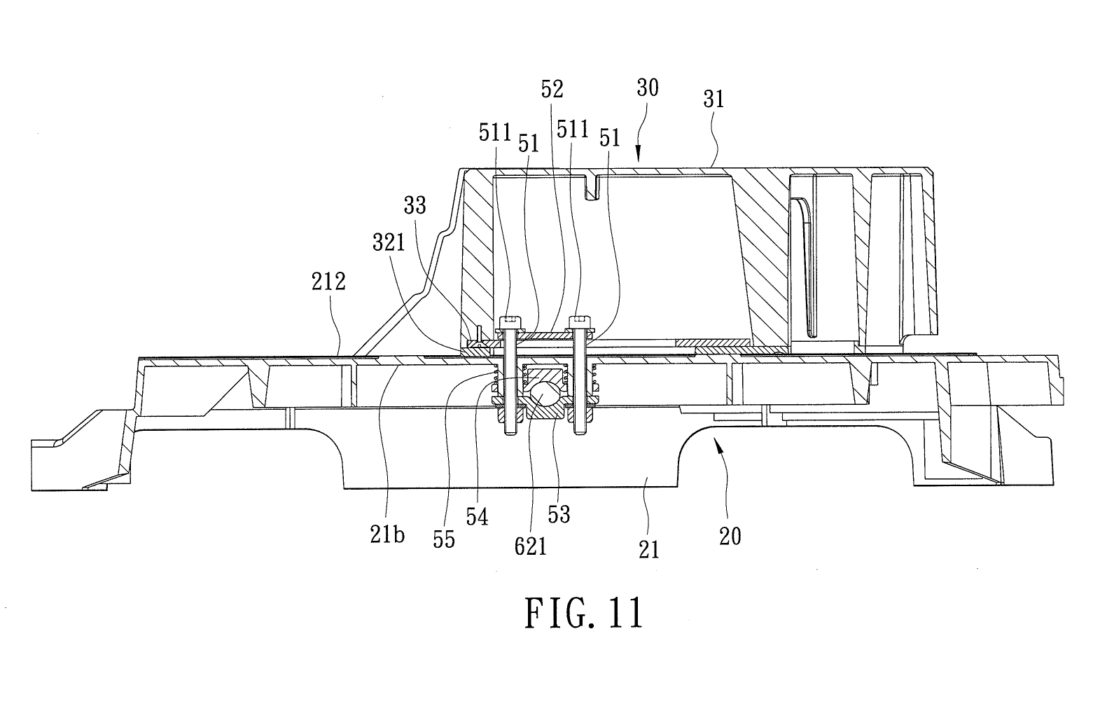

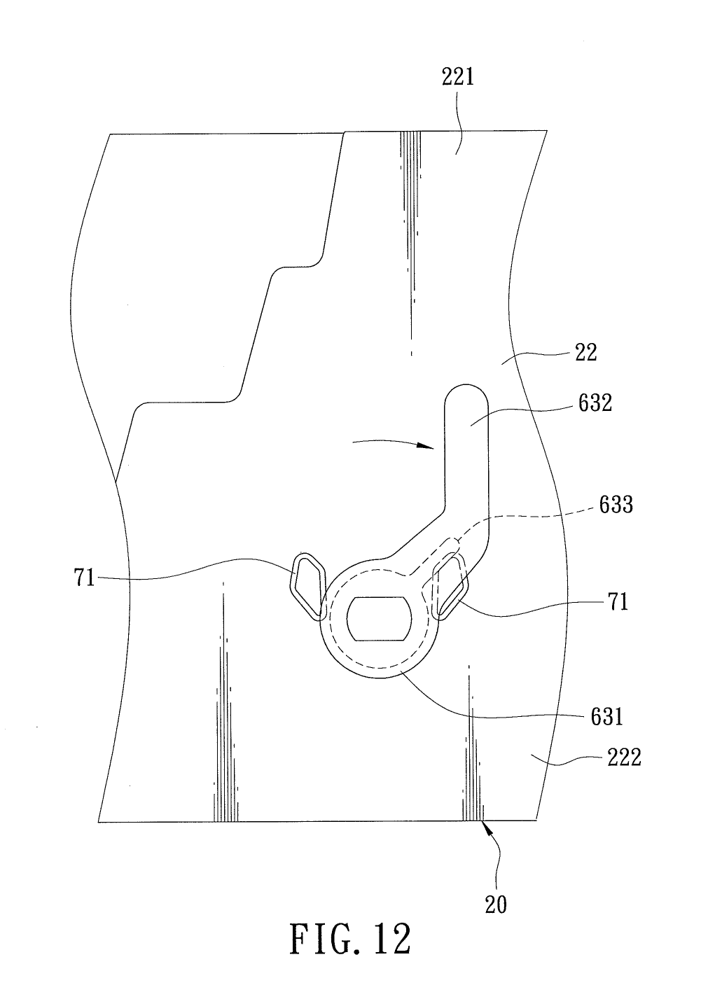

Referring to FIGS. 10, 11 and 12, when it is desired to increase the turning angle of the worktable 40, the handle 631 of the left and right actuators 60 is turned to permit the protrusion 633 to abut against the rear stopper 71. At this stage, the respective tightening mechanism 50 is displaced to the movable position. Specifically, the bolts 51 are moved to bring the slidable arcuate web 321 into loose engagement with the arcuate rail unit 213, and the bearing member 54 is moved away from the lower major wall surface (21b) by means of the coil springs 55, thereby permitting the respective platform 30 to be movable along the guiding route 213. FIG. 10 illustrates the state in which the worktable 40 has a largest turning angle.

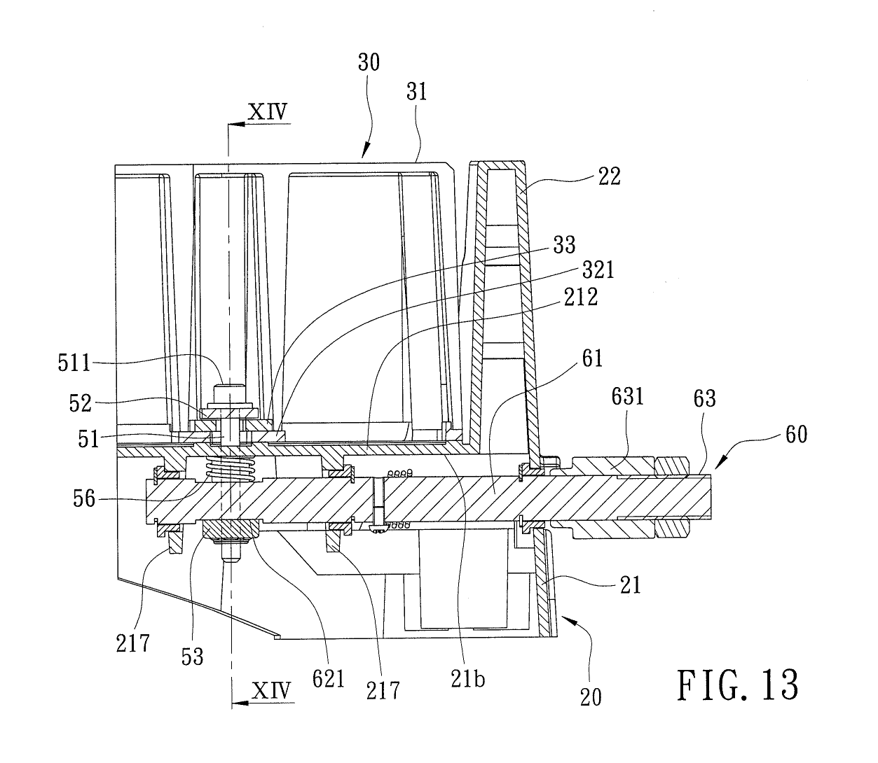

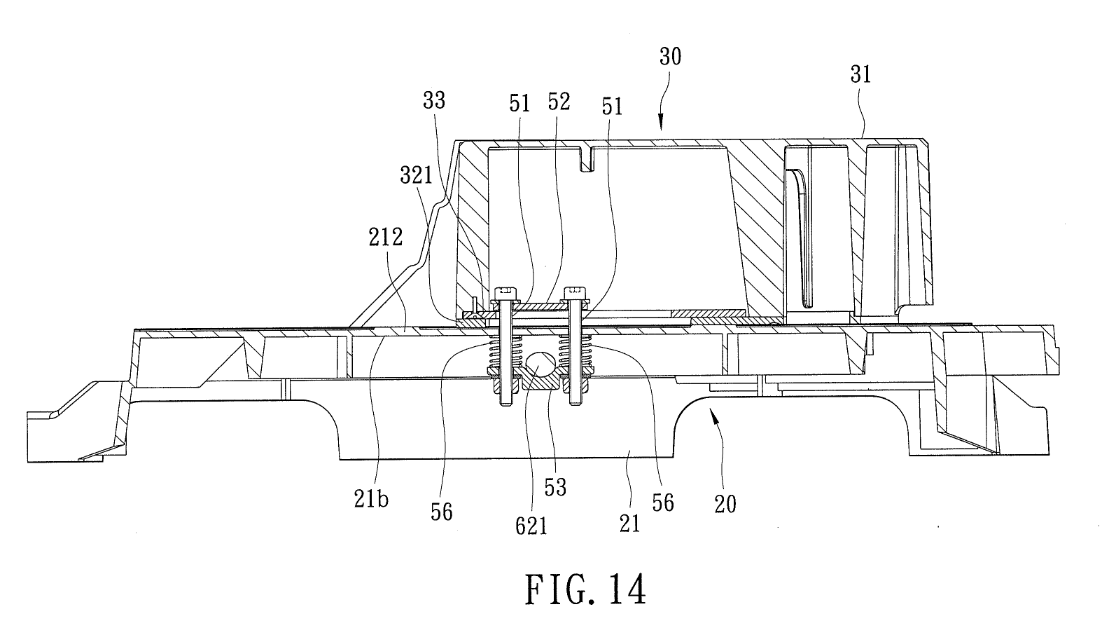

Referring to FIGS. 13 and 14, the second preferred embodiment of a workpiece supporting device according to this invention is similar to the first embodiment in construction, except that, in this embodiment, the lower major wall surface (21b) of the base frame 21 has two support ribs 217 such that the shank 61 is supported on the support ribs 217, and two coil springs 56 are respectively sleeved on the lower ends of the bolts 51, and are disposed between the lower major wall surface (21b) and the cam follower 53 to bias the cam follower 53 downwardly and away from the lower major wall surface (21b).

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

We claim:

1. A workpiece supporting device of a circular sawing machine which includes a circular saw unit that is cantileveredly mounted over said workpiece supporting device and that is pivotably movable toward and away from said workpiece supporting device, said workpiece supporting device comprising:
a base frame having a major wall to which a central axis is normal, and which has upper and lower major wall surfaces opposite to each other in an upright direction, said upper major wall surface having a central area which has a circumferential borderline surrounding the central axis, a frontward surface region which extends radially and forwardly of said circumferential borderline and which angularly extends about the central axis, and an arcuate surface region which extends rearwardly from said frontward surface region, said arcuate surface region defining a guiding route which extends angularly about the central axis;
a mount extending uprightly to form a sidewall segment and a base segment that rests on a flat surface, said mount flanking said arcuate surface region, and being configured to suspend said arcuate surface region from the flat surface such that said base segment is disposed below said lower major wall surface;
a worktable which has an outer periphery aligned with said circumferential borderline and superimposed on said central area, said worktable having an upper table surface which defines a cutting line that extends from the central axis towards a foremost point of said frontward surface region, and that serves as a reference for guiding movement of the circular saw unit toward said workpiece supporting device for cutting a workpiece;
a platform which is disposed to be movable along said guiding route so as to turn about the central axis, and which has an upper mounting surface that cooperates with said upper table surface to support the workpiece;
a tightening mechanism disposed to be displaceable between an unmovable position, where said platform is brought into tight engagement with said arcuate surface region, and a movable position, where said platform is brought into loose engagement with said arcuate surface region; and
an actuator including
a shank which is rotatably mounted in said base segment of said mount about a rotating axis, and which extends along the rotating axis,
an actuated end which is disposed inwardly of said shank, and which is configured to couple with said tightening mechanism so as to displace said tightening mechanism from the unmovable position to the movable position, thereby permitting said platform to be movable along said guiding route, and
an operated end which extends from said shank and outwardly of said base segment of said mount so as to facilitate manual turning of said shank about the rotating axis.

2. The workpiece supporting device according to claim 1, wherein said arcuate surface region has an arcuate rail unit which serves as said guiding route, said platform having a bottom frame which is spaced apart from said upper mounting surface and which includes a slidable arcuate web that extends angularly about the central axis to be guided to slide on said arcuate rail unit.

3. The workpiece supporting device according to claim 2, wherein said arcuate rail unit includes inner and outer arcuate rails which are spaced apart from each other by an arcuate zone;
said slidable arcuate web having an arcuate slot which extends therethrough, and which is aligned with said arcuate zone in the upright direction;
said tightening mechanism including a bolt unit which is engaged with and is movable relative to said arcuate zone in the upright direction, and which extends in the upright direction through said arcuate slot to terminate at an enlarged head that is movable relative to said slidable arcuate web in the upright direction to bring said slidable arcuate web into tight and loose engagement with said arcuate zone when said tightening mechanism is displaced to the unmovable and movable positions, respectively.

4. The workpiece supporting device according to claim 3, wherein said bolt unit includes two bolts which are angularly spaced apart from each other, said platform further including a force-focusing member which is configured to resemble said slidable arcuate web, and which is superimposed upon said slidable arcuate web so as to focus a pressing force emanating from said enlarged head onto said slidable arcuate web.

5. The workpiece supporting device according to claim 4, wherein said tightening mechanism further including an elongated washer body which has two through bores for extension of said bolts therethrough respectively, and which are configured to force said force-focusing member to abut against said slidable arcuate web.

6. The workpiece supporting device according to claim 5, wherein said bolts extend downwardly to terminate respectively at lower ends that are disposed below said lower major wall surface of said base frame;
said tightening mechanism further including a cam follower which interconnects said lower ends and which has a follower surface confronting said lower major wall surface;
said actuated end of said actuator having a cam which is turnable with said shank about the rotating axis and which is rotatably engaged with said follower surface such that turning of said cam results in movement of said enlarged head in the upright direction relative to said slidable arcuate web so as to bring said slidable arcuate web into tight and loose engagement with said arcuate zone when said tightening mechanism is displaced to the unmovable and movable positions, respectively.

7. The workpiece supporting device according to claim 6, wherein said tightening mechanism further includes a bearing member which interconnects and which is movable relative to said lower ends in the upright direction, and which has a bearing surface that confronts said follower surface and that permits said cam to be rotatable thereon such that turning of said cam results in movement of said bearing member to abut against and to be away from said lower major wall surface when said tightening mechanism is displaced to the unmovable and movable positions, respectively.

8. The workpiece supporting device according to claim 7, wherein said tightening mechanism further includes two coil springs which are respectively sleeved on said lower ends, and which are disposed between said lower major wall surface and said bearing member so as to bias said bearing member downwardly and away from said lower major wall surface.

9. The workpiece supporting device according to claim 6, wherein said tightening mechanism further includes two coil springs which are respectively sleeved on said lower ends, and which are disposed between said lower major wall surface and said cam follower to bias said cam follower downwardly and away from said lower major wall surface.

10. The workpiece supporting device according to claim 1, further comprising a stopping unit which is disposed on said base segment of said mount to limit an extent of turning of said operated end about the rotating axis.

11. The workpiece supporting device according to claim 2, wherein said slidable arcuate web is made from a wear-resistant material.
